(19) United States
(12) Patent Application Publication
(10) Pub. No.: US 2006/0006568 A1
(43) Pub. Date: Jan. 12, 2006

(54) Method of making a grab handle

(75) Inventors: Glenn A. Cowelchuk, Chesterfield, MI (US); Robert J, Adams, Ypsilanti, MI (US); Kenneth W. Shaner, Howell, MI (US); Nelson E. Williams JR., Saline, MI (US); John D. Youngs, Southgate, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 10/885,425

(22) Filed: Jul. 6, 2004

(51) Int. Cl. B29C 44/12

(52) U.S. Cl. 264/46.4; 264/309; 264/308; 264/255

(57) ABSTRACT

A method of making an interior vehicle part for use with a motor vehicle includes spraying material proximate a surface of a mold portion of a mold to form a skin layer, the surface defining a mold cavity of the mold portion. The method further includes positioning an insert proximate the mold cavity, the insert being configured for attachment to the vehicle, and introducing material into the mold cavity to form a foam layer that contacts the skin layer and the insert.

### BACKGROUND OF THE INVENTION

1. Field of the Invention

The invention relates to a method of making an interior vehicle part, such as a grab handle.

2. Background Art

A prior method of making a grab handle involves positioning a metal bracket in a mold and injection molding plastic material around the bracket. Because the plastic material is typically rigid, the grab handle does not have a soft feel.

A prior method of making a vehicle arm rest involves injection molding a plastic substrate in a first mold and roto-casting a cover layer or skin in a second mold. A bracket may also be inserted into the first mold during formation of the substrate, and the substrate may be molded directly onto the bracket. Moreover, the skin may be painted after the roto-casting process to achieve a desired color and gloss. The substrate and skin are then positioned in a third mold such that the substrate and skin are spaced apart from each other. Expandable foam is then introduced between the substrate and skin.

Because multiple molds are involved in the above method, tooling costs are significant. Furthermore, because the components must be transferred from one mold to another, the method may be time consuming to implement.

### SUMMARY OF THE INVENTION

Under the invention, a method of making an interior vehicle part for use with a motor vehicle is provided. The method includes the steps of spraying material proximate a surface of a mold portion of a mold to form a skin layer, the surface defining a mold cavity of the mold portion; positioning an insert proximate the mold cavity, the insert being configured for attachment to the vehicle; and introducing material into the mold cavity to form a foam layer that contacts the skin layer and the insert.

### BRIEF DESCRIPTION OF THE DRAWINGS

FIG. 1 is a top view of a grab handle according to the invention for use with a motor vehicle;

FIG. 2 is a cross-sectional view of the grab handle taken along line 2-2 of FIG. 1;

FIG. 3 is a plan view of a mold for use in making the grab handle, wherein the mold is shown in an open position;

FIG. 4 is a cross-sectional view of the mold taken along line 4-4 of FIG. 3 and showing application of in-mold coatings on the mold;

FIG. 5 is a cross-sectional view of the mold showing application of skin layers on the in-mold coatings;

FIG. 6 is a plan view of the mold showing an insert positioned on the mold;

FIG. 7 is a cross-sectional view of the mold showing application of foamable material on the skin layers; and

FIG. 8 is a cross-sectional view of the mold shown in a closed position.

### DETAILED DESCRIPTION OF THE PREFERRED EMBODIMENT(S)

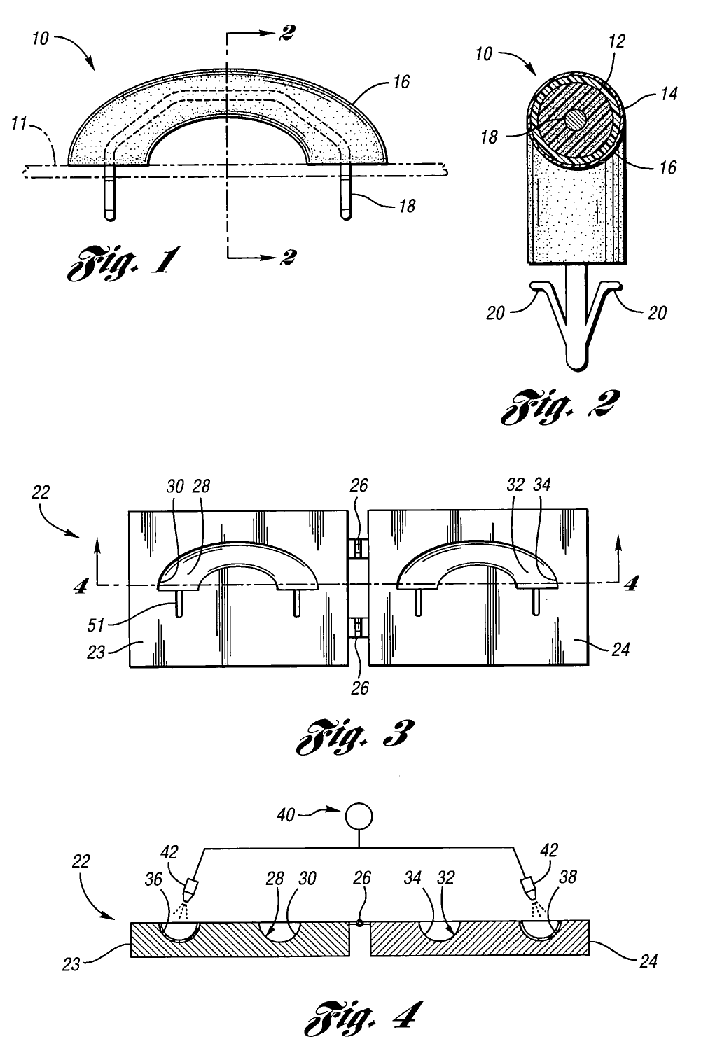

FIGS. 1 and 2 show an interior vehicle part, such as a grab handle 10, according to the invention for use with a vehicle 11. The grab handle 10 includes a foam substrate 12, a skin layer 14 surrounding the substrate 12, and a top coating 16 that covers the skin layer 14 and provides an exterior appearance surface. The grab handle 10 further includes an insert 18, such as a bracket, for supporting the substrate 12 and for attaching the grab handle 10 to the vehicle 11.

The substrate 12 may comprise any suitable foam material. For example, the substrate 12 may comprise an elastomer such as expanded polyurethane. Furthermore, the density of the substrate 12 is preferably, but not necessarily, in the range of 0.024 to 0.19 grams per cubic centimeter (g/cm³). Advantageously, the substrate 12 may be configured to provide the grab handle 10 with a soft feel.

The substrate 12 may also be substantially thicker than the skin layer 14 and coating 16 combined. Alternatively, the substrate 12 may have any suitable thickness.

The skin layer 14 is adhered to the substrate 12 and coating 16. Moreover, the skin layer 14 is configured to provide a resilient covering over the substrate 12 and may comprise any sufficiently dense material. For example, the skin layer 14 may be a solid layer that comprises an aromatic or aliphatic compound. As a more specific example, the skin layer 14 may be made of an elastomer such as polyurethane. Furthermore, the skin layer 14 may have any suitable thickness and density. For example, the skin layer 14 may have a thickness in the range of 0.3 to 10 millimeters (mm), and a density in the range of 0.15 to 1.5 g/cm³. In one embodiment of the invention, the skin layer 14 has a thickness in the range of 0.8 to 1.2 mm.

The coating 16 may be used to protect the skin layer 14 and/or to provide a decorative surface for the grab handle 10. For example, the coating 16 may be used to inhibit sunlight or other ultraviolet light from reaching the skin layer 14. As another example, the coating 16 may be used as a paint to provide a desired color or texture to the grab handle 10. While the coating 16 may comprise any suitable material, in one embodiment of the invention the coating 16 is made of an aliphatic polyurethane composition. Furthermore, the coating 16 may have any suitable thickness, such as a thickness in the range of 0.5 to 1.5 mils.

Alternatively, the coating 16 may be omitted if not required for a particular application. For example, the skin layer 14 may be configured to provide a sufficiently durable and attractive surface such that the coating 16 is not needed.

The insert 18 may have any suitable configuration sufficient for attachment to the vehicle 11. For example, the insert 18 may include attachment features, such as clips 20, that are engageable with a panel of the vehicle. Furthermore, the insert 18 may be made of any suitable material such as plastic or metal.

Referring to FIGS. 3-8, a method of manufacturing the grab handle 10 will now be described. FIG. 3 shows a mold 22 that may be used to make the grab handle 10. The mold 22 includes first and second mold portions 23 and 24, respectively, that may be separate or connected together. For example, the mold portions 23 and 24 may be pivotally connected together, such as with hinges 26. The mold 22 is moveable between an open position in which the mold portions 23 and 24 are spaced apart from each other, as shown in FIGS. 3-7, and a closed position in which the mold portions 23 and 24 are disposed adjacent to and in contact with each other, as shown in FIG. 8. The first mold portion 23 includes a first mold surface 28 that defines a first mold cavity 30, and the second mold portion 24 includes a second mold surface 32 that defines a second mold cavity 34. In addition, the mold portions 23 and 24 may be heated to any suitable temperature if desired.

The method begins by spraying a mold release agent on each mold surface 28 and 32. Next, referring to FIG. 4, a first in-mold coating 36 is sprayed on the first mold surface 28, and a second in-mold coating 38 is sprayed on the second mold surface 32 using any suitable device, such as a robotic spray assembly 40 having one or more moveable spray heads 42. While the coatings 36 and 38 may be made of any suitable material, in one embodiment, the coatings 36 and 38 comprise colored polyurethane. Furthermore, the coatings 36 and 38 cooperate to form coating 16 of the finished grab handle 10.

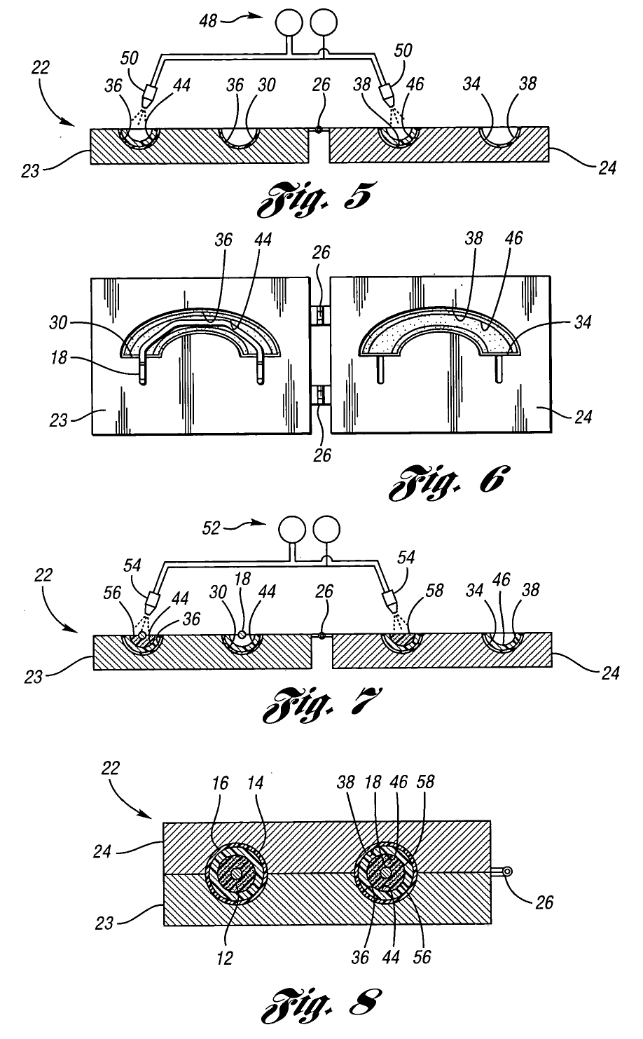

Next, referring to FIG. 5, the method involves spraying skin layer forming material into the mold cavities 30 and 34 and onto the coatings 36 and 38 to form a first skin layer 44 that bonds to the first coating 36, and a second skin layer 46 that bonds to the second coating 38. The material may be any suitable substance and may be applied using any suitable device. For example, the material may include polyol and isocyanate, and the material may be sprayed with a robotic spray assembly 48 having one or more moveable spray heads 50. As a result, the skin layers 44 and 46 may be formed of polyurethane. Furthermore, the skin layers 44 and 46 cooperate to form the skin layer 14 of the finished grab handle 10.

As mentioned above, the coating 16 may be omitted from the grab handle 10. In such a case, the skin layer forming material may be sprayed directly onto the mold surfaces 28 and 32, or onto a mold release agent that is applied on the mold surfaces 28 and 32, to form skin layers 44 and 46.

The method then includes positioning insert 18 proximate one of the mold portions 23 and 24. For example, each mold portion 23 and 24 may have a positioning feature or locator, such as a groove 51, for receiving the insert 18. In the embodiment shown in FIG. 6, the insert 18 is positioned on the first mold portion 23 such that the insert 18 extends above and adjacent to the first mold cavity 30.

Next, referring to FIG. 7, the method involves introducing foam forming material into each mold cavity 30 and 34 and onto each skin layer 44 and 46 to form foam, which bonds to the skin layers 44 and 46. The foam forming material may be any suitable substance and may be applied in any suitable manner. For example, the foam forming material may comprise polyol, isocyanate and a blowing agent such as water and/or a readily volatile organic substance. A specific example of a suitable blowing agent is DABCO® BL-17 available from Air Products and Chemicals, Inc. of Allentown Pa. Furthermore, the material may be sprayed with a robotic spray assembly 52 including one or more spray heads 54, and the material may be allowed to free rise to achieve a desired density. With the material described above, the foam may be formed of expanded polyurethane.

Furthermore, the foam forming material may be applied on each skin layer 44 and 46 when the mold 22 is in the open position, such that a first foam layer 56 is formed on the first skin layer 44 and a second foam layer 58 is formed on the second skin layer 46. With this approach, the mold 22 may then be moved to the closed position shown in FIG. 8 to allow further expansion and/or bonding of the foam layers 56 and 58, such that the foam layers 56 and 58 cooperate to form the substrate 12. The substrate 12 also contacts and adheres to the insert 18.

Alternatively, the foam forming material may be sprayed or otherwise injected into the mold cavities 30 and 34 when the mold 22 is in the closed position, thereby forming the substrate 12. Under this approach, the mold 22 may be provided with one or more suitable injection passages (not shown) for introducing the material into the mold cavities 30 and 34.

When the mold 22 is moved to the closed position, the skin layers 44 and 46 cooperate to form the skin layer 14, and the coatings 36 and 38 cooperate to form the coating 16. Furthermore, the skin layers 44 and 46 may bond to each other, and the coatings 36 and 38 may also bond to each other, when the mold 22 is in the closed position.

Under the invention, a single mold may be used to form the grab handle 10, or other interior vehicle part. Thus, the method of the invention involves less tooling than prior art methods in which components are formed in separate molds.

Examples of other vehicle parts that may be made by the above method include arm rests and rollover bars.

Although separate spray assemblies 40, 48 and 52 are shown in the Figures, the spray assemblies 40, 48 and 52 may be provided as a single spray assembly that is configured to spray all of the above described materials. Furthermore, if the material to be sprayed includes multiple substances, the substances may be mixed at any suitable time. For example, the substances may be mixed upstream of, within, or downstream of associated spray heads.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of making an interior vehicle part for use with a motor vehicle, the method comprising:
spraying material proximate a surface of a mold portion of a mold to form a skin layer, the surface defining a mold cavity of the mold portion;
positioning an insert proximate the mold cavity, the insert being configured for attachment to the vehicle; and
introducing material into the mold cavity to form a foam layer that contacts the skin layer and the insert.

2. The method of claim 1 wherein the mold includes an additional mold portion having an additional mold surface that defines an additional mold cavity, and wherein the mold is positionable in a closed position in which the mold portions are disposed adjacent each other, and wherein the introducing step comprises injecting material between the mold portions when the mold is in the closed position.

3. The method of claim 1 wherein the mold includes an additional mold portion having an additional mold surface that defines an additional mold cavity, and wherein the mold is positionable in an open position in which the mold portions are spaced apart from each other, and a closed position in which the mold portions are disposed adjacent each other, and wherein the introducing step comprises spraying material in each mold cavity when the mold is in the open position to form the foam layer in the mold cavity and an additional foam layer in the additional mold cavity.

4. The method of claim 3 further comprising spraying material proximate the additional mold surface to form an additional skin layer prior to the step of spraying material in the additional mold cavity to form the additional foam layer.

5. The method of claim 4 further comprising applying a coating on the surface of each mold portion, the coatings cooperating to form an appearance surface of the part.

6. The method of claim 1 further comprising applying a coating on the surface of the mold portion prior to the spraying step, the coating forming an appearance surface of the part.

7. The method of claim 1 wherein the skin layer comprises polyurethane.

8. The method of claim 1 wherein the foam layer comprises an expanded elastomer.

9. The method of claim 1 wherein the foam layer comprises polyurethane.

10. A method of making a grab handle for use with a motor vehicle, the method comprising:
spraying material proximate a first surface of a first mold portion of a mold to form a first skin layer that comprises polyurethane, the first surface defining a first mold cavity;
spraying material proximate a second surface of a second mold portion of the mold to form a second skin layer that comprises polyurethane, the second surface defining a second mold cavity;
positioning a bracket proximate at least one of the mold cavities, the bracket being configured for attachment to the vehicle;
spraying material into the mold cavities to form foam that contacts the skin layers; and
closing the mold portions together such that the bracket is disposed between the mold portions.

11. The method of claim 10 wherein the closing step is performed prior to the step of spraying material into the mold cavities to form foam.

12. The method of claim 10 wherein the step of spraying material into the mold cavities to form foam is performed prior to the closing step.

13. The method of claim 10 further comprising applying a coating on each of the first and second surfaces prior to the spraying steps, the coatings cooperating to form an appearance surface of the grab handle.

14. The method of claim 10 wherein the skin layers each comprise polyurethane.

15. The method of claim 10 wherein the foam comprises an expandable elastomer.

16. The method of claim 10 wherein the foam comprises polyurethane.

17. A method of making an interior vehicle part for use with a motor vehicle, the method comprising:
spraying material proximate a first surface of a first mold portion of a mold to form a first skin layer that comprises polyurethane, the first surface defining a first mold cavity;
spraying material proximate a second surface of a second mold portion of the mold to form a second skin layer that comprises polyurethane, the second surface defining a second mold cavity;
spraying material into the mold cavities to form foam that contacts the skin layers; and
closing the mold portions together such that the skin layers are disposed between the mold portions.

18. The method of claim 17 wherein the closing step is performed prior to the step of spraying material into the mold cavities to form foam.

19. The method of claim 17 wherein the step of spraying material into the mold cavities to form foam is performed prior to the closing step.
